(19) United States
(12) Patent Application Publication
(10) Pub. No.: US 2010/0039246 A1
(43) Pub. Date: Feb. 18, 2010

(54) REMOTE CONTROL FOR AUTOMOBILE TRUNK

(76) Inventor: PEI-CHENG CHIU, Kaohsiung City (TW)

Correspondence Address: LEONG C LEI, PMB # 1008, 1867 YGNACIO VALLEY ROAD, WALNUT CREEK, CA, 94598, US

(21) Appl. No.: 12/192,125

(22) Filed: Aug. 15, 2008

(51) Int. Cl. B60R 25/00

(52) U.S. Cl. 340/426.13

(57) ABSTRACT

A remote control is provided for an automobile trunk and includes a trunk lock that is selectively driven by a power unit for unlocking and a control device controlling the power unit, wherein the control device is coupled to an anti-burglary host device that is originally installed in the automobile or various anti-burglary devices controlled thereby, whereby operating the anti-burglary devices of the automobile by a remote control emitter of the automobile-originally-equipped anti-burglary host device can be preserved and remote controlled operation of the automobile trunk by means of the remote control emitter of the automobile-originally-equipped anti-burglary host device can be realized to thereby enhance the operability of the automobile trunk.

### TECHNICAL FIELD OF THE INVENTION

The present invention generally relates to a remote control for an automobile trunk, and more particularly to remote controlling of the automobile trunk with an automobile-originally-equipped remote control emitter.

### DESCRIPTION OF THE PRIOR ART

Most automobiles, when shipped to the dealers, are additionally equipped with an anti-burglary system 1. As shown in FIG. 1, the anti-burglary system 1 generally comprises a remote control emitter 11 and an anti-burglary host device 12 installed in the body of the automobile. The remote control emitter 11 is carried by an owner of the automobile, while the anti-burglary host device 12 that is installed in the automobile body is coupled to a central door lock 121, an ignition system 122, a fuel supply system 123, and a sound/lighting (headlights and horns) alarm system 124 of the automobile, so that when the automobile owner, within an effective receipt distance of the anti-burglary host device 12, activates the remote control emitter 11 to release the settings of various anti-burglary instructions, the central door lock 121 of the automobile is unlocked, and the ignition system 122 and the fuel supply system 123 are put in normal standby conditions. The automobile owner may then open a door to get in the automobile and insert a key in the ignition switch to start up the engine. On the other hand, when arriving at a destination, the automobile owner leaves the automobile and activates the remote control emitter 11 again to issue a locking instruction. The anti-burglary host device 12 then responsively sets the ignition system 122 and the fuel supply system 123 in fuel-off and power-off conditions and the central door lock 121 is locked, whereby the automobile is now set in an anti-burglary condition.

Further, as shown in FIG. 2, in most luxury cars, the anti-burglary system 1 installed in the cars is further provided with a signal line that extends from the anti-burglary host device 12 to a trunk driving motor 21. Once the remote control emitter 11 is maintained in a depressed condition for a given period of time, the anti-burglary host device 12 issues a signal to the trunk driving motor 21 to cause the operation of the trunk driving motor 21 for driving a control cable or pull rod of the trunk, thereby effecting an unlocking operation of the trunk lock 2 and realizing automatic opening of the trunk.

However, for those low-level automobiles, they are only equipped with the simple-configuration anti-burglary system 1, which cannot carry out unlocking operation of the trunk by being controlled by the remote control emitter 11. On the other hand, the luxury cars are expensive, which are often not affordable to the general consumers. Thus, to integrate the regular trunk lock with the automobile-originally-equipped anti-burglary system, but still preserving the original functions of the automobile-originally-equipped anti-burglary system so as to provide cheap cars with the controllability of the trunk with a remote control in the same way as the luxury cars do is a challenge to the manufacturers of this industry.

### SUMMARY OF THE INVENTION

An objective of the present invention is to provide a remote control for an automobile trunk. The remote control of the automobile trunk comprises a power unit and is driven by the power unit to effect unlocking of the automobile trunk lock. The power unit is controlled by a control device, and the control device is coupled to an anti-burglary host device that is originally built in the automobile or various anti-burglary devices controlled by the anti-burglary host device, wherein the control device comprises a central processing unit (CPU) based automatic control circuit, which is coupled to a power supply and regulation system and a relay switching and power output system, whereby the setting and releasing operation of the automobile anti-burglary devices controlled by a remote control emitter 51 of the automobile-originally-equipped anti-burglary host device can be preserved, and using the remote control emitter of the automobile-originally-equipped anti-burglary host device to effect remote control of unlocking of the automobile trunk lock can also be realized, so as to provide upgrading of the controllability of the automobile trunk and the usefulness of the automobile.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a conventional anti-burglary system.

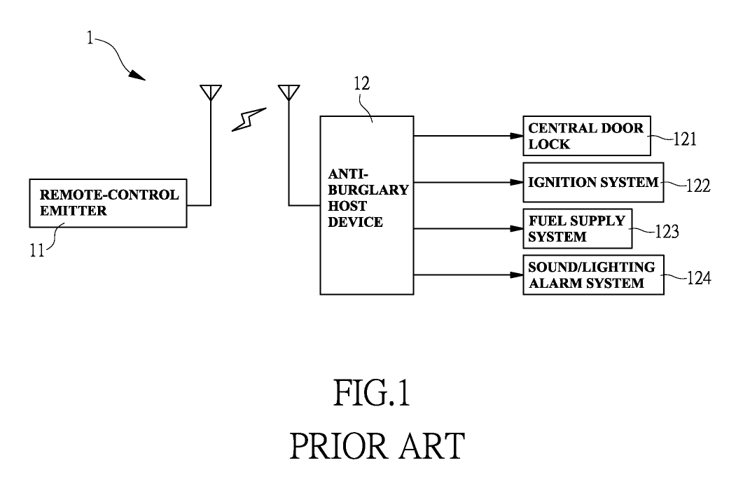

FIG. 2 is a schematic view illustrating integration of a conventional automobile anti-burglary system with a trunk lock.

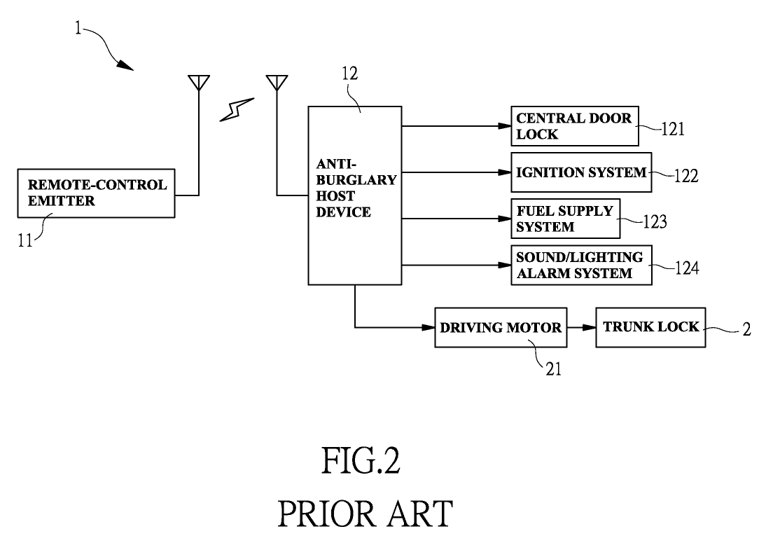

FIG. 3 is a block diagram of the present invention.

FIG. 4 is a block diagram illustrating an application of the present invention.

FIG. 5 is a block diagram of another embodiment of the present invention.

FIG. 6 is a block diagram of a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

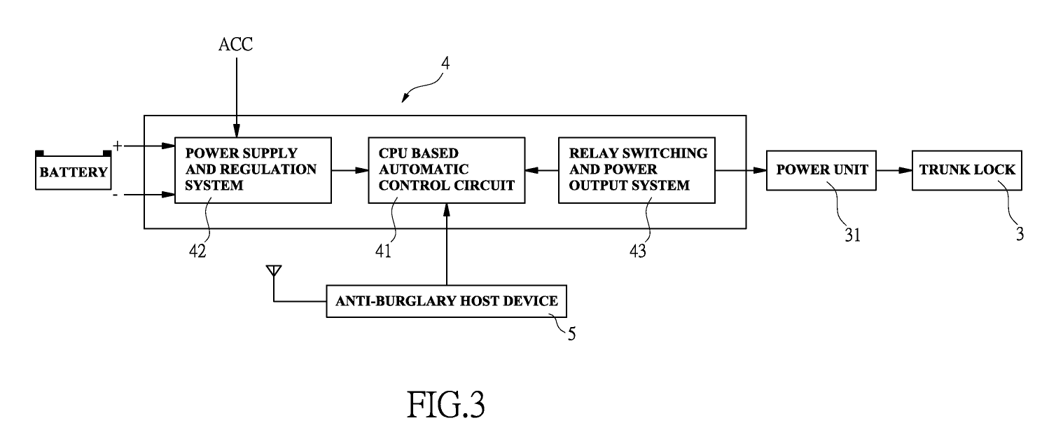

As shown in FIG. 3, a remote control constructed in accordance with the present invention is provided for controlling a trunk of an automobile and comprises a trunk lock 3 and a control device 4. The trunk lock 3 is operated by a power unit 31 through a steel control cable or a pull rod to unlock. The control device 4 comprises at least a central processing unit (CPU) based automatic control circuit 41, which is connected to a power supply and regulation system 42 and a relay switching and power output system 43. The control device 4 is further coupled to an automobile-originally-equipped anti-burglary host device 5.

The CPU based automatic control circuit 41 is designed for interconnection with the automobile-originally-equipped anti-burglary host device 5 and functions to detect an output signal generated by the anti-burglary host device 5, as well as signals or pulses for effecting setting and releasing of anti-burglary functions of various anti-burglary devices 6, such as detecting a signal or pulses for locking and unlocking a central door lock of the automobile, detecting a signal or pulses for turning on/off headlights, detecting a signal or pulses for activating an automobile horn or buzzer, and a signal or pulses for activating or de-activating a fuel/electricity cutting off device.

The power supply and regulation system 42 is connected to a power source built in the automobile, such as an automobile battery set.

The relay switching and power output system 43 serves as a power output system and the relay switching and power output system 43 is put into operation by a power output signal.

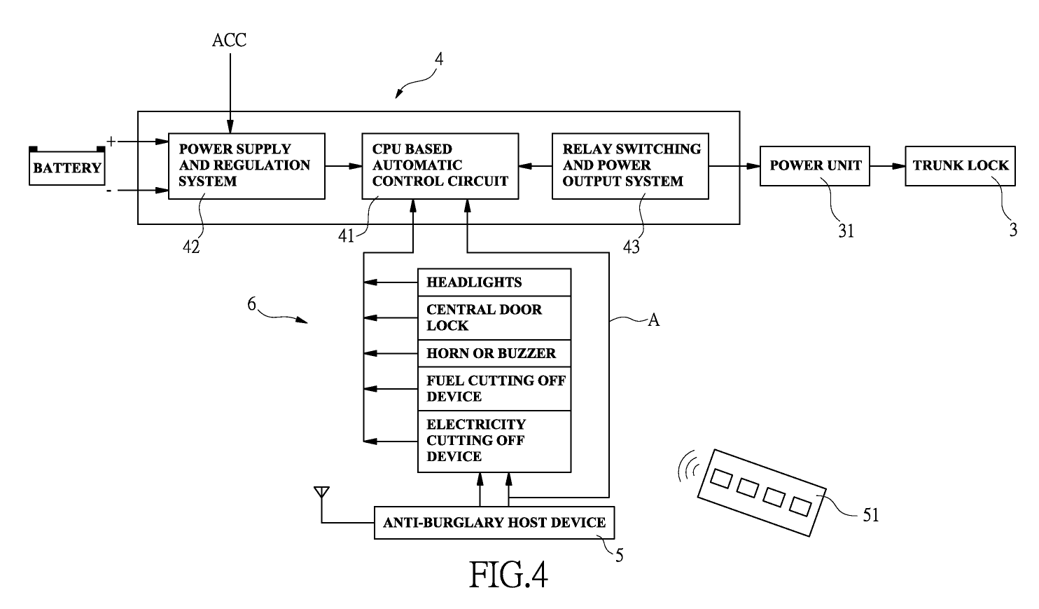

To practice the present invention, as shown in FIG. 4, the control device 4 is connected to the power unit 31 of the trunk lock 3 of the automobile. The power unit 31 can be embodied as a driving motor or a solenoid control. The control device 4 is connected to the anti-burglary host device 5 of the originally installed anti-burglary system of the automobile through the CPU based automatic control circuit 41 thereof and functions to detect an operation signal A supplied from the automobile-originally-equipped anti-burglary host device 5 and signals or pulses for controlling activation/operation releasing of the automobile anti-burglary devices 6, such as detecting the signals or pulses for setting/releasing the anti-burglary devices 6 including the central door lock, the headlights, the horn/buzzer, and the fuel electricity cutting off device, and, once detecting such signals or pulses, issues an instruction to cause the relay switching and power output system 43 to output power. Further, in practice, the CPU based automatic control circuit 41 of the present invention can be designed to supply the instruction that causes the relay switching and power output system 43 to output power only when the operation signal A from the automobile-originally-equipped anti-burglary host device 5 for lasting for a preset number of seconds (preferably 1 to 5 seconds) and/or the signals or pulses for activating/operation-releasing of one or more than one of the automobile anti-burglary devices 6 has been detected, in order to ensure the correctness of the operation of the relay switching and power output system 43 and to reduce the likelihood of false operation.

Thus, when the automobile owner momentarily operates an originally-equipped remote control emitter 51 within an effective distance from the automobile to cause the automobile-originally-equipped anti-burglary host device 5 to carry out setting of the anti-burglary devices, the anti-burglary host device 5, after receiving the instruction signal from the remote control emitter 51, follows the original configuration thereof to supply signals for carrying out setting operations of the various anti-burglary devices. At this time, the operation signal A supplied from the anti-burglary host device 5 and the signals or pulses generated when the various anti-burglary devices 6 carry out the setting operations are transmitted to the CPU based automatic control circuit 41 of the control device 4 in accordance with the present invention. Although the CPU based automatic control circuit 41 detects and confirms correctness of the operation signal A supplied from the anti-burglary host device 5 and also confirms the compliance with the item number and conditions of the anti-burglary devices preset therein, yet due to the fact that the time period of the operation of depressing the originally-equipped remote control emitter 51 is momentary in carrying out the anti-burglary setting operation and also due to the fact that the anti-burglary host device 5 at the receiver end supplies only a momentary output signal, which can be even shorter than one second, under these conditions, preset timing parameters of the CPU based automatic control circuit 41 at that time are not satisfied. Therefore, the CPU based automatic control circuit 41 does not take any action, namely not supplying the instruction to cause the operation of the relay switching and power output system 43, and the automobile only carries out the originally-configured setting operation for the various anti-burglary devices 6.

When the automobile owner wishes to releases the anti-burglary setting of the automobile and momentarily operates the originally-equipped remote control emitter 51 within an effective distance to cause the automobile-originally-equipped anti-burglary host device 5 to carry out setting releasing operation of the anti-burglary devices 6, the anti-burglary host device 5 follows the original configuration thereof to supply the operation signal A for carrying out setting releasing operations of the various anti-burglary devices. The operation signal A supplied from the anti-burglary host device 5 and the signals or pulses generated when the various anti-burglary devices 6 carry out the setting releasing operations are transmitted to the CPU based automatic control circuit 41 of the control device 4 in accordance with the present invention. Although the CPU based automatic control circuit 41 detects and confirms correctness of the operation signal A supplied from the anti-burglary host device 5 and also confirms the compliance with the item number of the anti-burglary devices 6 preset therein, yet as mentioned above, the operation of depressing the originally-equipped remote control emitter 51 is momentary and the signal output of the anti-burglary host device 5 at the receiver end is momentary and shorter than one second, so that the signal output of the anti-burglary host device 5 is too short to satisfy the preset timing parameters of the CPU based automatic control circuit 41 at that moment and thus the CPU based automatic control circuit 41 does not take any action, namely not supplying any instruction to cause the operation of the relay switching and power output system 43, and the automobile only carries out the originally configured releasing operation for the various anti-burglary devices 6.

However, when the automobile owner wishes to have the trunk of the automobile automatically opened and operates the originally-equipped remote control emitter 51 within an effective distance to cause the automobile-originally-equipped anti-burglary host device 5 to carry out setting releasing operation of the various anti-burglary devices 6, whereby the anti-burglary host device 5 follows the original configuration to output the operation signal A in order to carry out setting releasing operation of the various anti-burglary devices 6. At this time, by continuously maintaining depression of the originally-equipped remote control emitter 51, making the originally-equipped remote control emitter 51 continuously issuing instruction signals, and the anti-burglary host device 5 at the receiver end correspondingly and continuously supplies the operation signal A. Thus, the anti-burglary host device 5 continuously supplies the operation signal A to the CPU based automatic control circuit 41 to satisfy the preset timing parameters of the CPU based automatic control circuit 41, whereby the CPU based automatic control circuit 41 issues an instruction that causes the operation of the relay switching and power output system 43. The power unit 31 is thus immediately instructed to drive the steel control cable or the pull rod to unlock the trunk lock 3, realizing remotely-controlled automatic opening of the trunk of the automobile.

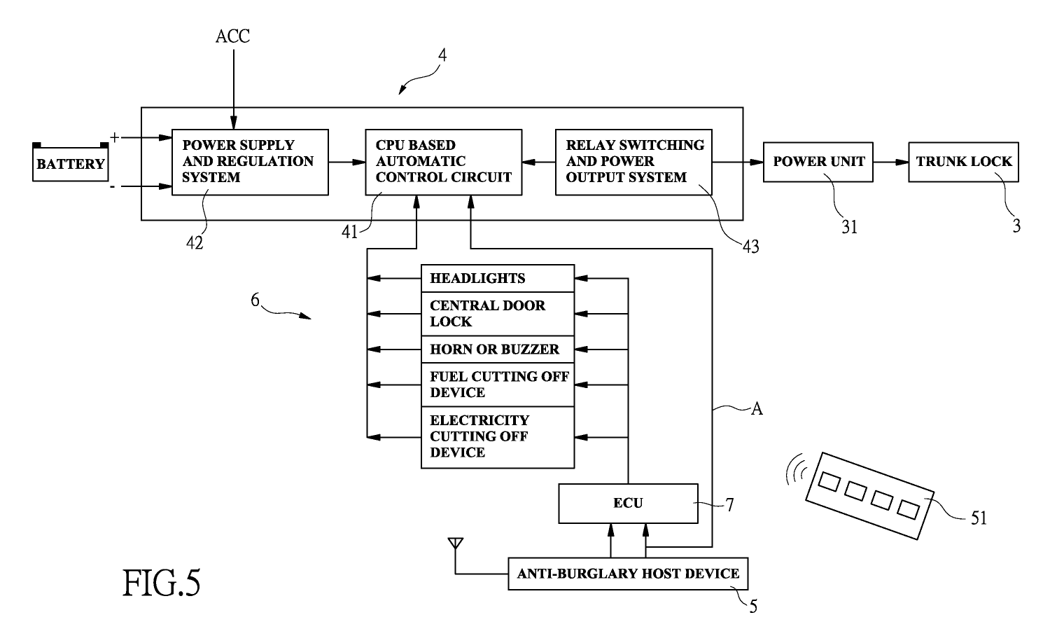

Further, some automobiles are provided with a main-body electronic control unit (ECU) 7 and the setting and releasing of various anti-burglary devices 6 in such automobiles are operated in such a way that when the anti-burglary host device 5 receives an instruction from the remote control emitter 51, the anti-burglary host device 5 outputs the operation signal A to the main-body ECU 7 and then the main-body ECU 7 supplies instruction for setting and releasing of the various anti-burglary devices 6. Thus, as shown in FIG. 5, the control device 4 of the present invention is made connected to the anti-burglary host device 5, while the anti-burglary host device 5 is connected to the main-body ECU 7, so that the instruction of setting and releasing of the various anti-burglary devices 6 is issued by the main-body ECU 7.

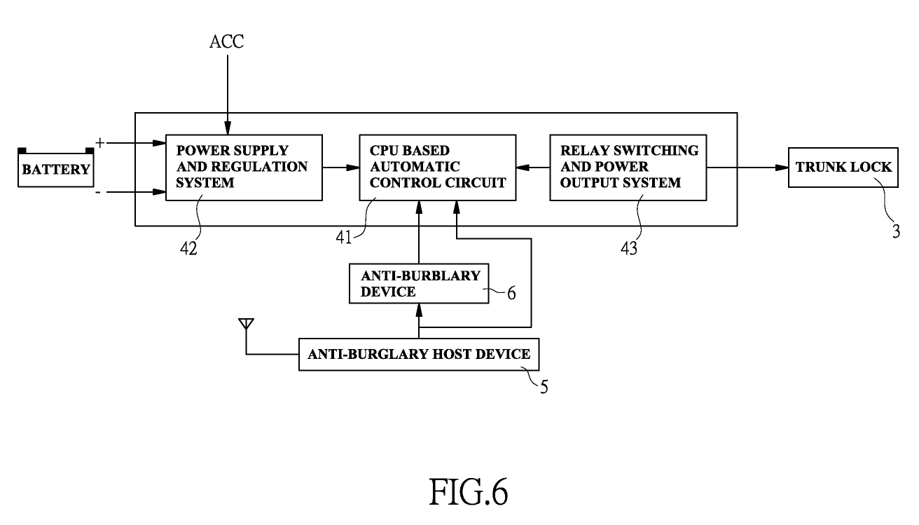

Alternatively, as shown in FIG. 6, in the remote control of automobile trunk in accordance with the present invention, the control device 4 can be made in direct connection with the anti-burglary devices 6 that are controlled by the automobile-originally-equipped anti-burglary host device 5 and one or more than one of the anti-burglary devices 6 can be selected to couple thereto. By means of the direct connection with the anti-burglary devices 6 controlled by the anti-burglary host device 5, it is also possible to detect the operation signal A supplied from the anti-burglary host device 5 and the signals or pluses of the operations of the anti-burglary devices 6 connected thereto in carrying out setting or releasing operations. Since the control device 4 is directly connected to the anti-burglary devices 6 controlled by the automobile-originally-equipped anti-burglary host device 5, the installation of the control device 4 in accordance with the present invention can be done easily, providing the advantage of efficient electrical connection with the automobile.

The effectiveness of the present invention is that with the power unit 31 of the automobile trunk lock 3 coupled to the control device 4 and the control device 4 further connected to the automobile-originally-equipped anti-burglary host device 5 or the anti-burglary devices 6 controlled by the anti-burglary host device 5, when the originally-equipped remote control emitter 51 of the anti-burglary system that is originally built in the automobile is operated in an effective distance to set or release the anti-burglary devices 6, the CPU based automatic control circuit 41 built in the control device 4 detects the operation signal A supplied from the anti-burglary host device 5 and the signals or pulses generated when the various anti-burglary devices 6 of the automobile are set or released; and the CPU based automatic control circuit 41 of the control device 4 is loaded with preset timing parameters to obtain effective control over the operation of the CPU based automatic control circuit 41, whereby remotely-controlled automatic opening of the automobile trunk can be realized and controlled. As such, the automobile trunk lock is integrated with the anti-burglary system that is originally built in the automobile, whereby a regular car can possess the same remotely-controlled automatic trunk opening function as a luxury car and enhancing automobile functions and easy controllability are also realized.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A remote control for automobile trunk, at least comprising:
an automobile trunk lock, which is selectively driven by a power unit to unlock;
a control device, which comprises at least a central processing unit (CPU) based automatic control circuit, which is connected to a power supply and regulation system and a relay switching and power output system and is further coupled to an anti-burglary host device of an automobile anti-burglary system;
wherein the CPU based automatic control circuit of the control device is designed to detect an operation signal supplied from the anti-burglary host device of the automobile anti-burglary system and to detect signals or pulses for effecting setting and releasing of anti-burglary functions of various anti-burglary devices so that when the anti-burglary host device carries out setting or releasing operations of the anti-burglary devices, the CPU based automatic control circuit of the control device receives the operation signal supplied from the anti-burglary host device and the signals and pulses of the setting or releasing of the anti-burglary devices of the automobile and so that the CPU based automatic control circuit of the control device acquires correct operation timing, allowing the opening of the automobile trunk to be effectively controlled and performed.

2. The remote control for automobile trunk according to claim 1, wherein the control device is in connection with the anti-burglary host device of the automobile anti-burglary system and the anti-burglary host device is in turn connected to a main-body electronic control unit (ECU) of the automobile, the main-body ECU being set in connection with the anti-burglary devices of the automobile.

3. The remote control for automobile trunk according to claim 1, wherein the CPU based automatic control circuit is designed to supply an instruction that causes the relay switching and power output system to output power only when detecting at least the signals or pulses for activating/operation-releasing of one or more than one of the anti-burglary devices of the automobile.

4. The remote control for automobile trunk according to claim 1, wherein the CPU based automatic control circuit is designed to supply an instruction that causes the relay switching and power output system to output power only when detecting at least the operation signal from the anti-burglary host device for lasting for a preset number of seconds.

5. The remote control for automobile trunk according to claim 1, wherein the power unit comprises a driving motor.

6. The remote control for automobile trunk according to claim 1, wherein the power unit comprises a solenoid control.

7. The remote control for automobile trunk according to claim 1, wherein the CPU based automatic control circuit has a preset timing parameter of 1 to 5 seconds.

8. A remote control for automobile trunk, at least comprising:
an automobile trunk lock, which is selectively driven by a power unit to unlock;
a control device, which comprises at least a central processing unit (CPU) based automatic control circuit, which is connected to a power supply and regulation system and a relay switching and power output system and is further coupled to various anti-burglary devices controlled by an anti-burglary host device of an automobile anti-burglary system;
wherein the CPU based automatic control circuit of the control device is designed to detect an operation signal supplied from the anti-burglary host device of the automobile anti-burglary system and to detect signals or pulses for effecting setting and releasing of anti-burglary functions of the various anti-burglary devices so that when the anti-burglary host device carries out setting or releasing operations of the anti-burglary devices, the CPU based automatic control circuit of the control device receives the operation signal supplied from the anti-burglary host device and the signals and pulses of the setting or releasing of the anti-burglary devices of the automobile and so that the CPU based automatic control circuit of the control device acquires correct operation timing, allowing the opening of the automobile trunk to be effectively controlled and performed.

9. The remote control for automobile trunk according to claim 8, wherein the CPU based automatic control circuit is designed to supply an instruction that causes the relay switching and power output system to output power only when detecting at least the signals or pulses for activating/operation-releasing of one or more than one of the anti-burglary devices of the automobile.

10. The remote control for automobile trunk according to claim 8, wherein the CPU based automatic control circuit is designed to supply an instruction that causes the relay switching and power output system to output power only when detecting at least the operation signal from the anti-burglary host device for lasting for a preset number of seconds.

11. The remote control for automobile trunk according to claim 8, wherein the power unit comprises a driving motor.

12. The remote control for automobile trunk according to claim 8, wherein the power unit comprises a solenoid control.

13. The remote control for automobile trunk according to claim 8, wherein the CPU based automatic control circuit has a preset timing parameter of 1 to 5 seconds.
